(19) United States
(12) Patent Application Publication
(10) Pub. No.: US 2007/0039380 A1
(43) Pub. Date: Feb. 22, 2007

(54) Device for measuring hydralic roughness of the internal surface of a pipeline

(76) Inventor: Yves Charron, Longpont sur Orge (FR)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 10/572,315

(22) PCT Filed: Sep. 17, 2004
(86) PCT No.: PCT/FR04/02363

§ 371 Date: Oct. 18, 2006

(30) Foreign Application Priority Data
Sep. 18, 2003 (FR) 03/11054

(51) Int. Cl. G01B 5/28

(52) U.S. Cl. 73/105

(57) ABSTRACT

The device 1 for determining the hydraulic roughness of the internal surface of a pipe 2 has a trolley 4 with wheels 3. Drum 5 is mounted to be rotationally movable on trolley 4. The roughness is determined by measuring the resisting torque of drum 5 or by measuring the dynamic pressure given by Pitot tubes 11. The translationally movable trolley 4 has the advantage of being able to measure the roughness at different points in pipe 2.

The present invention relates to a device for measuring the hydraulic roughness of the internal surface of a pipe.

At the present time, natural gas is carried in compressed form over long distances in gas pipelines. The transport pressure is 7 MPa in the case of a land-based pipe but can be as high as 30 MPa in the case of a submarine pipe. In most cases, the natural gas carried has at least 90% methane.

This transport is far more expensive than carrying oil by tanker, which limits the development of natural gas operations. Hence reducing transport costs is an essential financial objective in view of the large outlays required.

When fluids are carried by circulating in a pipe, for example natural gas carried by a gas pipeline, the condition of the pipe's internal surface plays an important role: the roughness of the pipe's internal surface has a direct effect on pressure losses. It is useful to know the hydraulic roughness to optimize fluid circulation conditions (flowrate, speed of circulation, and pressure). The hydraulic roughness of the internal surface of a gas pipeline can also be a parameter in optimizing the positions of the recompression stations disposed along a new gas pipeline or optimizing the repositioning of the recompression stations along a used gas pipeline. The hydraulic roughness can be measured on new or used portions of gas pipelines, the internal surfaces of which have been modified by corrosion or by paraffin deposition.

FR 2,778,460 teaches a device for measuring the aerodynamic characteristics of a surface. However, this device does not enable measurements to be made inside oil or gas pipelines.

Thus, the present invention proposes a translationally movable device for determining the hydraulic roughness of the internal surface of a pipe whose length is far greater than its diameter.

In general, the present invention relates to a device for determining the roughness of a pipe internal surface. The device has: a trolley with wheels resting on the internal surface of the pipe, a first drum mounted in rotationally movable fashion on the trolley, and a first sensor mounted on the trolley, the first sensor measuring a parameter representing the friction of a fluid located between the first drum and the internal surface of the pipe.

The device according to the invention can have a means for moving the trolley in the pipe, for example a membrane opposing the circulation of fluid in the pipe.

According to the invention, the axis of the first drum can be substantially the same as the axis of the pipe.

The device according to the invention can include a second drum mounted to be rotationally movable on the trolley, the axis of the second drum being substantially the same as the axis of the pipe, with the first drum rotating in the opposite direction to the second drum.

The device according to the invention can include a second sensor measuring the rotational speed of the first drum, a third sensor measuring the pressure of the fluid inside the pipe, and a fourth sensor measuring the temperature of the fluid in the pipe.

The first sensor can be a torquemeter measuring the torque of the first drum, or a Pitot tube measuring the dynamic pressure of the fluid between the first drum and the internal surface of the pipe.

The present invention also relates to a method for using the device to determine the roughness of the internal surface of the pipe. The method comprises the following steps:
a) the device is placed in the pipe,
b) the first drum is made to rotate,
c) at least one value of a parameter is measured with the first sensor, said parameter representing the friction of the fluid located between the first drum and a first portion of the internal surface of the pipe, said first portion facing the first drum,
d) the roughness of the first portion of the internal surface of the pipe is measured by comparing the value measured in step c) with a set of previously measured values of the parameter, each value of said set corresponding to a known roughness of a surface.

Additionally, according to the invention, the trolley can be moved in the pipe and the roughness of a second portion of the internal surface of the pipe can be determined by running steps c) and d).

The set of previously measured values can be obtained by running steps a), b), and c) with a pipe whose internal surface roughness is known.

According to the invention, the set of previously measured values can include relationships expressing the ratio between the velocities of a fluid located between the drum and the pipe, the velocities being relative to the drum and to the pipe, as a function of the Reynolds number, the relationships being established for several surfaces of known roughness.

According to the invention, in step c) one can additionally measure the rotational speed of the first drum [and¹] the pressure and temperature of the fluid located between the first drum and the internal surface of the pipe, and in step d) one can determine the roughness of the pipe internal surface taking into account the speed, pressure, and temperature measured in step c).
¹Word inserted by translator.

Other characteristics and advantages of the invention will be better understood and emerge clearly from reading the description hereinbelow referring to the drawings wherein:

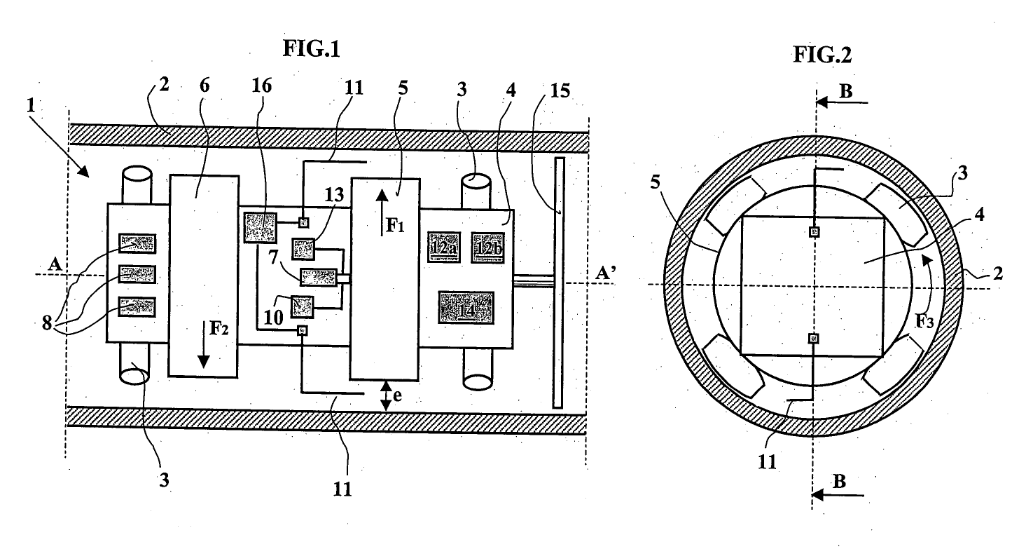

FIG. 1 shows schematically a lengthwise view of the device according to the invention;

FIG. 2 shows schematically a cross-sectional view of the device according to the invention;

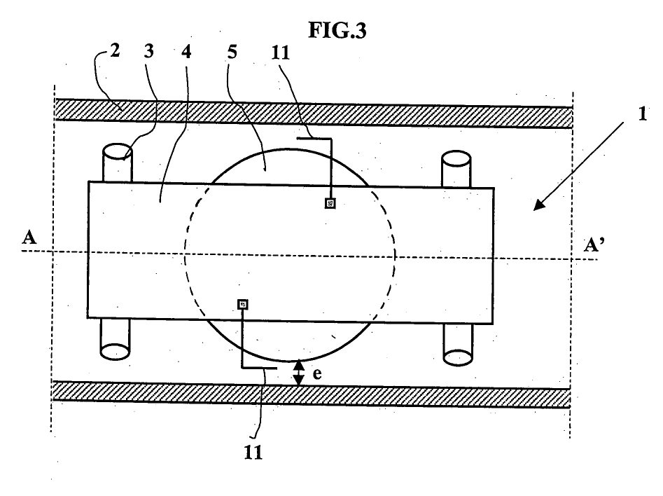

FIG. 3 shows schematically a lengthwise view of a variant of the device according to the invention;

With reference to FIGS. 1 and 2, the device 11 for measuring the hydraulic roughness of the internal surface of pipe 2 has a frame² 4 provided with wheels 3. In general, the internal surface of pipe 2 is a cylinder with a circular cross section. Pipe 2 carries a fluid, for example natural gas.
²French bâti. In the claims, and occasionally elsewhere in the specification, the term used is chariot 4 (trolley 4). Translator.

Wheels 3 enable device 1 to be moved translationally in the direction of axis A-A′ of pipe 2. The dimensions of wheels 3 and frame 4 can be chosen such as to center the frame 4 in pipe 2.

Membrane 15, integral with frame 4, enables device 1 to be pushed opposite the direction of movement of the fluid carried in pipe 2. For example, the membrane has a disk shape and is disposed in a plane substantially perpendicular to axis A-A′. Device 1 can be displaced by other means. For example, device 1 is pulled through pipe 2 by a cable.

Drum 5 is mounted to be rotationally movable on frame 1, with the drum rotating in a plane perpendicular to axis A-A′. Drum 5 can be in the shape of a surface of revolution, for example in the form of a circular cylinder. In FIG. 1, the direction of rotation is indicated by arrow F1. The dimensions of frame 4 and wheels 3 and the position of drum 5 on the frame are chosen such that the drum is able to rotate about essentially the same axis as axis A-A′ of pipe 2. The motor 7 installed on frame 4 allows drum 5 to be actuated rotationally. Motor 7 can be an electric motor supplied by batteries 8.

Rotation of drum 5 entrains the fluid at its periphery by friction. The fluid flows with the same movement as that of drum 5, i.e. in a circular direction as indicated by arrow F3 in FIG. 2. However, the movement of the fluid is braked by the fixed wall of pipe 2. The fluid friction generates a resisting torque on the drive shaft of drum 5. The friction and hence the resisting torque are in proportion to the roughness of the internal surface of pipe 2. This torque can be measured by torquemeter 10 mounted on the drive shaft of drum 5. The torquemeter furnishes an average measurement of roughness over the entire circumference of a portion of pipe 2 opposite drum 5.

The velocity profile of the fluid between drum 5 and the wall of pipe 2 also depends on the roughness of the internal surface of pipe 2. The velocity of the fluid in gap e between drum 5 and the internal surface of pipe 2 can be measured by Pitot tubes 11. Each Pitot tube is connected to a differential pressure sensor 16 to measure the dynamic pressure. The velocity of the fluid can also be measured by any other anemometric sensor such as a hot wire. Measurement of velocity by a Pitot tube 11 furnishes a local measurement over the circumference of pipe 2. Several Pitot tubes 11 can be distributed over the entire circumference of drum 5. Thus, the roughness of the internal surface of pipe 2 can be measured locally at various positions over the circumference of pipe 2.

The variant of device 1 according to the invention shown in FIG. 3 relates to the position of drum 5. The trolley 4 provided with wheels 3 is disposed in pipe 2. Drum 5 is mounted to be rotationally movable on trolley 4, the axis of rotation of drum 5 being perpendicular to axis A-A′ of pipe 2. Drum 5 can be in the shape of a surface of revolution, for example in the form of a circular cylinder or barrel. The Pitot tubes 11 measure the dynamic pressure of the fluid in the gap e between drum 5 and the internal surface of pipe 2.

The width of gap 3 can be between 20 mm and 40 mm. However, this dimension can be reduced or increased. A small gap value, for example between 5 mm and 20 mm, enables measurement sensitivity to be increased, particularly the measurement made by torquemeter 10. A gap value greater than 40 mm limits the likelihood of a Pitot tube 11 contacting the internal surface of pipe 2.

The rotational speed of the cylinder is chosen according to the roughness value to be measured. The lower the roughness values to be measured, the more the thickness of the viscous layer in the area close to rotating drum 5 must be reduced so that the velocity of the fluid at the periphery of drum 5 must be increased, and hence the more the rotational speed of drum 5 must be increased.

In FIG. 1, frame 4 is also provided with sensors 12a and 12b that measure the pressure and temperature of the fluid contained in pipe 2. All the measurements by sensors 10, 11, 12a, 12b, and 13 can be recorded by the recording means 14 mounted on frame 4. The fluid pressure and temperature enable the fluid density and fluid viscosity to be determined. From the dynamic pressure measured by Pitot tubes 11 and the fluid density, the fluid flowrate through the Pitot tube is determined. The measurements recorded by means 14 can be analyzed and processed after a measurement series, for example once device 1 has carried out a measurement series in a section of pipeline.

To prevent the frame from rotating, the inertia of drum 5 is selected to be as small as possible relative to the inertia of frame 4. Also, frame 1 is designed such that the center of gravity of device 1 is as low as possible relative to axis A-A′, and the counter-torque of drum 5 is at least less than about half the torque needed to set frame 4 rotating, i.e. less than the torque needed to position the center of gravity of frame 4 on a horizontal plane passing through axis A-A′.

For the device shown in FIG. 1, the rotation of drum 5 can be facilitated by passing fluid through the frame, then through fins mounted inside drum 5.

In FIG. 1, the device 1 can include a second drum 6. In this case, the direction of rotation of drum 6 indicated by arrow F2 is preferably in the direction opposite the rotation of drum 5 indicated by arrow F1. Thus, the counter-torque of drum 5 offsets the counter-torque of drum 6. Hence, the total torque of the two drums is essentially zero, preventing frame 4 from rotating. Each of drums 5 and 6 can be equipped with a different motor so that the counter-torque on each drum can be measured. Each of drums 5 and 6 can also be equipped with Pitot tubes. Advantageously, the position on the circumference of the Pitot tubes of drum 6 is different from the position on the circumference of the Pitot tubes of drum 5 in order to increase the number of local measurements.

Without departing from the framework of the invention, it is possible to equip frame 4 with several drums divided into two groups, one group of drums rotating in the opposite direction to that of the other group of drums.

Device 1 is pre-calibrated as described below.

Device 1 is placed in a pipe 2 whose physical internal-surface roughness has been determined.

Physical roughness designates a numerical value or a set of numerical values expressing the geometric state, i.e. geometric characteristics, of a surface. There are numerous standards defining physical roughness. For example, ISO standard 4287 defines physical roughness relative to the midline (Ra, Rt, Rz, etc.), ISO standard 12085 defines physical roughness relative to the motifs (R, Rx, W, Ar, Aw, etc.), and ISO standard 13565 defines roughness relative to the lifting curve (Rpk, Rvk, Rk, Rmr (c), etc.). Physical roughness can be determined with a contact measuring device such as a feeler, or a microscope for viewing the surface.

Also, to calibrate the device, pipe 2 contains a known fluid at a known temperature and known pressure. Drum 5 is made to rotate, and resisting torque measurements are made with torquemeter 10 or dynamic pressure measurements are made with Pitot tubes 11. Measurements are made for several rotational speeds of drum 5, for several fluid pressures and temperatures, and for several physical roughness values of the internal surface of pipe 2.

Thus, a database is established covering several groups of values. Each group of values has a resisting torque value and values corresponding to the measurement conditions of this resisting torque, i.e. the physical roughness of the pipe 2 internal surface, the rotational speed of drum 5, the fluid temperature, the fluid pressure, and the fluid composition. Each group of values can also include a dynamic pressure value and values corresponding to the conditions under which this dynamic pressure was measured, i.e. the physical roughness of the pipe 2 internal surface, the rotational speed of drum 5, the fluid temperature, the fluid pressure, and the fluid composition.

The database can be organized advantageously. For a given pipe internal surface physical roughness, a relation f is established expressing a relationship between the velocity U1 of the fluid in the gap e relative to the internal surface of pipe 2 and the velocity U2 of the fluid in gap e relative to drum 5, as a function of a dimensionless number, for example the Reynolds number, depending on drum rotational speed N, pipe diameter D, fluid absolute viscosity μ, and fluid density ρ:

$$\frac{U 1}{U 2} = f ( N , D , μ , ρ ) .$$

The relationship can be established in the form of curves on a plot or in the form of analytical relationships.

The device according to the invention enables an equivalent roughness to be attributed to a surface whose physical roughness is unknown. The equivalent roughness is established from the hydraulic standpoint: according to the invention, the effect of the surface condition of a surface, whose physical roughness is unknown, on the flow of a fluid in contact with this surface is considered. Next, considering the pre-established database, one assigns to this surface, whose physical roughness is unknown, a physical roughness of another surface which has essentially the same effect on fluid flow, this other surface having served to establish the database. In the description of the invention, this equivalent roughness is called hydraulic roughness.

To determine the hydraulic roughness of an internal surface of a pipe with the device 1 described with reference to FIGS. 1, 2, and 3, the following steps may be followed.

The device 1 is placed in pipe 2, the axis of drums 5 and 6 being essentially the same as the axis A-A′ of pipe 2.

Pipe 2 is filled with a fluid, for example natural gas.

The device 1 is moved translationally along axis A-A′ of pipe 1. For example, the fluid in pipe 2 is made to flow at a given flowrate. Thus, device 1 moves at approximately the velocity of the fluid because of membrane 15. Device 1 can also be pulled by a cable.

Drum 5 is made to rotate.

The pressure and temperature of the fluid in pipe 2 are measured. The rotational speed of drum is measured. The resisting torque on the drive shaft of drum 5 is measured and/or the dynamic pressure of the fluid between drum 5 and the internal surface of pipe 2 is measured.

The hydraulic roughness of the internal surface of pipe 2 is measured, for example using the resisting torque value measured on the drive shaft of drum 5 and/or using the dynamic pressure value given by Pitot tubes 11.

To determine the hydraulic roughness, the measured values can be compared with the values in the pre-established database, the group of values best matching the measured values is selected from the database, and the roughness corresponding to the selected group is attributed to pipe 2 or the portion of pipe 2 opposite the drum at the time of measurement.

If the database is organized as relationships between the ratio between fluid velocities relative to pipe 2 and to drum 5 as a function of the Reynolds number for known physical roughnesses, one may proceed as follows. The viscosity and density of the fluid are calculated from measurements of pressure and temperature, and knowledge of the fluid's composition. The Reynolds number is calculated from viscosity, density, pipe diameter, and drum 5 rotational speed values. From the Reynolds number, the peripheral speed of drum 5, and the fluid velocity obtained by measuring the dynamic fluid pressure using a Pitot tube, the hydraulic roughness is determined using pre-established relationships giving the ratio between the fluid velocities relative to pipe 2 and to drum 5 as a function of the Reynolds number.

Other details for determining hydraulic roughness are given in patent FR 2,778,460.

The measurements can be made discretely, i.e. the measurements are made when device 1 is in one or more specific positions. Thus, the roughness of the pipe 2 internal surface is measured at one or more points corresponding to the position of drum 5 when the measurements were made. For example, the positions of the measurements in a pipe are spaced apart 1 meter to 100 meters.

The measurements can also be made continuously over a length of pipe 2. Thus, the internal surface roughness is determined throughout the length of pipe 2.

1) Device for determining the roughness of the internal surface of a pipe (2), said device having:
a trolley (4) with wheels (3) resting on the internal surface of the pipe (2),
a first drum (5) mounted in rotationally movable fashion on the trolley (4),
a first sensor (10; 11) mounted on trolley (4), the first sensor (10; 11) measuring a parameter representing the friction of a fluid located between the first drum (5) and the internal surface of pipe (2).

2) Device according to claim 1, having a means for moving the trolley in the pipe.

3) Device according to claim 2, wherein the means for moving the trolley in the pipe is a membrane (15) that opposes fluid circulation in the pipe.

4) Device according to claim 1 wherein the axis of the first drum (5) is substantially the same as the axis of pipe (2).

5) Device according to claim 4, having a second drum (6) mounted to be rotationally movable on trolley (4), the axis of the second drum (6) being substantially the same as the axis of the pipe (2), with the first drum (5) rotating in the opposite direction to the second drum (6).

6) Device according to claim 1, including a second sensor (13) measuring the rotational speed of the first drum (5), a third sensor (12a) measuring the pressure of the fluid inside pipe (2), and a fourth sensor (12b) measuring the temperature of the fluid in pipe (2).

7) Device according to claim 1, wherein the first sensor (10) is a torquemeter measuring the torque of the first drum (5).

8) Device according to claim 1, wherein the first sensor (1) is a Pitot tube measuring the dynamic pressure of the fluid between the first drum (5) and the internal surface of pipe (2).

9) Method for using the device according to claim 1 to determine the roughness of the internal surface of pipe (2), said method comprising the following steps:
a) the device is placed in pipe (2)
b) the first drum (5) is made to rotate
c) at least one value of a parameter is measured with the first sensor (10:11), said parameter representing the friction of the fluid located between the first drum (5) and a first portion of the internal surface of pipe (2), said first portion facing the first drum (5),
d) the roughness of the first portion of the internal surface of pipe (2) is measured by comparing the value measured in step c) with a set of previously measured values of the parameter, each value of said set corresponding to a known roughness of a surface.

10) Method according to claim 9, wherein the trolley (4) is moved in the pipe (2) and the roughness of a second portion of the internal surface of the pipe (2) is determined by running steps c) and d).

11) Method according to claim 9 wherein the set of previously measured values is obtained by running steps a), b), and c) with a pipe whose internal surface roughness is known.

12) Method according to claim 9, wherein the set of previously measured values includes relationships expressing the ratio between the velocities of a fluid located between the drum and the pipe, the velocities being relative to the drum and to the pipe, as a function of the Reynolds number, the relationships being established for several surfaces of known roughness.

13) Method according to claim 9, wherein in step c) one additionally measures the rotational speed of the first drum [and 1] the pressure and temperature of the fluid located between the first drum (5) and the internal surface of pipe (2), and wherein, in step d), the roughness of the internal surface of pipe 2) is determined taking into account the speed, pressure, and temperature measured in step c).
